(19) United States
(12) Patent Application Publication
(10) Pub. No.: US 2007/0169549 A1
(43) Pub. Date: Jul. 26, 2007

(54) Method and apparatus for sensing fuel levels in tanks

(75) Inventors: Hegeon Kwun, San Antonio, TX (US); Ronald H. Peterson, Helotes, TX (US)

Correspondence Address: KAMMER BROWNING PLLC, 7700 BROADWAY, SUITE 202, SAN ANTONIO, TX, 78209, US

(73) Assignee: Southwest Research Institute

(21) Appl. No.: 11/656,814

(22) Filed: Jan. 23, 2007

Related U.S. Application Data
(60) Provisional application No. 60/761,248, filed on Jan. 23, 2006.

(51) Int. Cl. G01F 23/22

(52) U.S. Cl. 73/290 V

(57) ABSTRACT

An apparatus and method are described that utilize longitudinal guided waves propagated along a rod placed in a vehicle fuel tank, or the like, to identify the level of the fuel contained within the tank. The system includes a magnetostrictive sensor (MsS) positioned adjacent to one end of the rod that extends out from the tank. The MsS both generates the guided waves in the rod and detects the reverberating reflected waves within the rod. A permanent magnet may be positioned adjacent the MsS to establish a bias magnetic field in association with the MsS. The system and method detect the waves reverberating in the rod and from the detected signals, measure a degree of wave attenuation. A correlation is made between the measured attenuation change and the actual fuel level within the tank.

### CROSS REFERENCE TO RELATED APPLICATIONS

This application claims the benefit under Title 35 United States Code §119(e) of U.S. Provisional Application No. 60/761,248 filed Jan. 23, 2006, the full disclosure of which is incorporated herein by reference.

### BACKGROUND OF THE INVENTION

1. Field of the Invention

The present invention relates generally to systems and methods for measuring the level of a liquid present in a container. The present invention relates more specifically to a vehicle fuel tank level measurement device and method that functions without the need for movable floats or other movable mechanical components.

2. Description of the Related Art

Fuel tank level gauges, such as those used as fuel gauges in automotive vehicles, are primarily float-and-rod type systems. The float follows the fuel level in the tank and causes the float rod to pivot. The displacement of the pivoted end of the float rod is sensed and related to the liquid (fuel) level. Typical examples of such systems are disclosed in “How Fuel Gauges Work,” which is reproduced at http:H/auto.howstuffworks.com/fuel-gauge.htm. Typically, the displacement is detected by using a resistive element with a sliding contact that acts as a variable resistor in an electrical/electronic measurement circuit.

The above described float-and-rod type fuel gauges, which have been in use for decades, suffer from significant mechanical wear as well as corrosion of the resistive sensing element and its contact points. This wear over time results from the constant cyclic rubbing of the contact points and from chemical attacks by various constituents in fuel during the vehicle lifetime. The mechanical wear and corrosion eventually lead to erroneous gauge readings and failure of the fuel gauge accurately function.

There are, of course, a wide variety of different ways that liquid levels in tanks can be measured. Examples of some of these are disclosed in K. Mambrice and H. Hopper, “A Dozen Ways to Measure Fluid Level and How They Work,” Sensors Vol. 21, No. 12 (December 2004). In addition, there are many patented methods and devices. Examples of these include; those based on bulk ultrasonic waves (see for example, U.S. Pat. No. 4,320,659, issued to Lynnworth, et al., on Mar. 23, 1982, entitled “Ultrasonic System for Measuring Fluid Impedance or Liquid Level”); magnetostrictive level sensing systems that measure differences in resonant frequencies (see for example, U.S. Pat. No. 6,418,787, issued to Eck on Jul. 16, 2002, entitled “Level Transmitter for a Liquid Container and Method for Determining the Level in a Liquid Container”, and U.S. Pat. No. 6,910,378, issued to Arndt on Jun. 28, 2005, entitled “Method for Determining a Level, and Level Measuring Device”); magnetostrictive level sensing systems that use torsional guided waves with a float (see for example, U.S. Pat. No. 3,898,555, issued to Tellerman, on Aug. 5, 1975, entitled “Linear Distance Measuring Device Using a Moveable Magnet Interacting with a Sonic Waveguide”, as well as U.S. Pat. No. 4,839,590, issued to Koski, et al., on Jun. 13, 1989, entitled “Piezoelectric Actuator for Magnetostrictive Linear Displacement Measuring Device”, U.S. Pat. No. 4,939,457, issued to Tellerman, on Jul. 3, 1990, entitled “Flexible Tube Sonic Waveguide for Determining Liquid Level”, U.S. Pat. No. 4,952,873, issued to Tellerman, on Aug. 28, 1990, entitled “Compact Head, Signal Enhancing Magnetostrictive Transducer”, U.S. Pat. No. 4,943,773, issued to Koski, et al., on Jul. 24, 1990, entitled “Magnetostrictive Linear Displacement Transducer Having Pre-Selected Zero Crossing Detector”, U.S. Pat. No. 5,189,911, issued to Ray, et al., on Mar. 2, 1993, entitled “Liquid Level and Temperature Sensing Device”, U.S. Pat. No. 5,473,245, issued to Silvus, Jr., et al., on Dec. 5, 1995, entitled “Magnetostrictive Linear Displacement Transmitter having Improved Piezoelectric Sensor”); or those based on the use of electromagnetic waves (see for example U.S. Pat. No. 6,293,142, issued to Pchelnikov, et al., on Sep. 25, 2001, entitled “Electromagnetic Method of Liquid Level Monitoring”, and U.S. Pat. No. 6,564,658, issued to Pchelnikov, et al., on May 20, 2003, also entitled “Electromagnetic Method of Liquid Level Monitoring”). Except for the mechanical float-type sensing approach, the other methods are rarely used for automotive fuel gauge applications due to their high cost, low reliability, and poor durability.

There is therefore a need for an accurate, reliable, and robust fuel level sensor that uses no moving parts that might be subject to deterioration and wear over time. It would be desirable if such a sensor could accurately determine a fuel level without the need for overly complex measurement systems or transducers. It would be preferable if such a fuel level sensor could operate in conjunction with fuel tank configurations that already exist, albeit for use in conjunction with float type fuel level sensors. It would be desirable if such a system could be implemented as original equipment on a new vehicle and/or as a replacement system on the fuel tank of an existing vehicle. It would be beneficial if the fuel level sensor described could operate with relatively simple signal analysis electronics, either with analog signal analysis components or simple digital circuitry signal analysis components. It would be helpful if such signal analysis electronics could report out an absolute level value, a percentage full value, or an absolute volume value, all based on knowledge of the tank geometry. Finally, it would be beneficial if the sensor system described could be implemented in a small package or enclosure that could easily be fixed at an external port on the fuel tank and not require significant modifications to the tank or its surrounding environment.

### SUMMARY OF THE INVENTION

The present invention relates to a method and a device for sensing the fuel level in a vehicle fuel tank (and conceptually to the measurement of liquid levels in a variety of liquid containment tanks) that require no float and no mechanical moving parts and, thus, provide a system that is much more robust and reliable than existing fuel tank gauges and, at the same time, is low cost. In addition to automotive fuel gauges, the present invention can also be applied to other fuel tanks such as those in airplanes, boats, railroad tanks, gas station tanks, propane tanks, etc. The system may be structured to be used in conjunction with a liquid tank without the need for significant alteration of the geometry or structural environment typically surrounding such vehicle fuel tanks.

The apparatus and method of the present invention utilize longitudinal guided waves propagated along a cylindrical rod or tube placed in a vehicle fuel tank, or the like, to identify the level of the fuel contained within the tank. The system and method detect the waves reverberating in the rod and from the detected signals, measure a degree of wave attenuation brought about by the extent to which the rod or tube is in contact with liquid within the tank versus being in contact only with air within the tank. A correlation is made between the measured attenuation change and the actual fuel level within the tank. Calibration and referencing of the system as a whole may be carried out when the tank is empty and selective referencing of the liquid level measurement signal to a first end-reflected wave can be made. The electronics associated with the system may be implemented as analog or digital circuit devices.

### BRIEF DESCRIPTION OF THE DRAWINGS

FIG. 1A is a graphic plot (over time) of a longitudinal wave signal in a steel rod in air.

FIG. 1B is a graphic plot (over time) of a longitudinal wave signal in a steel rod partially immersed in water.

FIG. 2 is a schematic view of the apparatus of the present invention installed on a tank containing a liquid.

FIG. 3 is schematic electronic block diagram of a first circuit for implementing the method of the present invention.

FIG. 4 is a schematic electronic block diagram of a second circuit for implementing the method of the present invention.

FIG. 5 is a flowchart of the broad steps of the method of the present invention.

### DETAILED DESCRIPTION OF THE PREFERRED EMBODIMENTS

As indicated above, the present inventive method utilizes longitudinal guided waves that are generated in, and are propagated along, a cylindrical rod or tube placed in a fuel tank. The system detects the waves reverberating in the cylindrical rod or tube and from the detected signals, measures a level of wave attenuation, and correlates the measured attenuation change to the fuel level. When liquid fuel is present around the rod or tube, the guided waves leak into the surrounding fuel through refraction. Because of this leakage, the wave attenuation increases with the increasing level of fuel or, more particularly, with the increased contact between the fuel and the cylindrical rod or tube. With proper referencing and calibration, as well as certain minimum information about the geometry and structure of the tank, an accurate correlation can be made between the degree of attenuation and the level of the fuel within the tank.

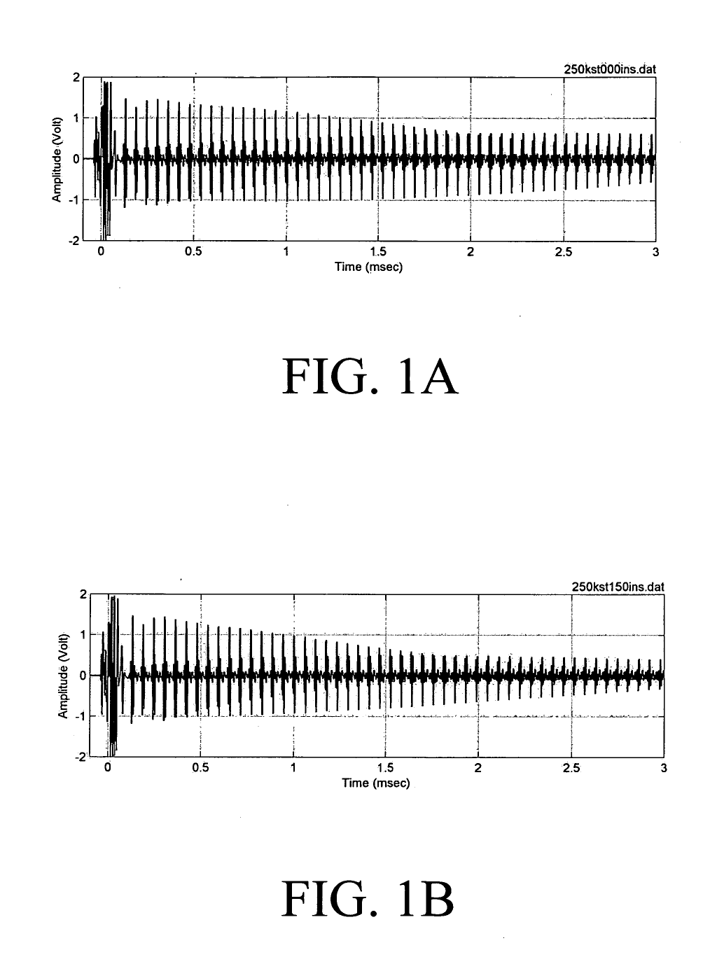

A comparison of the signals represented in graphic form in FIGS. 1A and 1B provides an example of the effects of a liquid on wave attenuation. The data in these examples were taken from an approximately 15 cm long, 2 mm diameter, steel rod. The “interrogating wave” was initiated by transmitting a pulse of 250 kHz longitudinal waves from near the top end of the rod and detecting the signals reverberating between the two ends of the rod. The waves were generated and detected, in this case, by using a magnetostrictive sensor (MsS), of the type patented by Southwest Research Institute (SwRI) of San Antonio, Tex. (see for example U.S. Pat. No. 5,457,994, issued to Kwun, et al., on Oct. 17, 1995, entitled “Nondestructive Evaluation of Non-Ferromagnetic Materials Using Magnetostrictively Induced Acoustic/Ultrasonic Waves and Magnetostrictively Detected Acoustic Emissions” and U.S. Pat. No. 6,396,262, issued to Light, et al., on May 28, 2002, entitled “Method and Apparatus for Short Term Inspection or Long Term Structural Health Monitoring”, each of which is commonly owned with the present application by SwRI, and the disclosures of which are each incorporated herein by reference).

The signal trace in FIG. 1A was obtained by generating and detecting waves within the rod while the rod was in air alone (i.e. no contact with liquid). The signal trace in FIG. 1B was obtained with approximately 37 mm of the rod immersed in water. As shown, although in each case the amplitude of the wave attenuated over time, the wave attenuation was higher when a portion of the rod was immersed in the water. As mentioned above, the cause of this increased attenuation is clearly the refraction of the wave into the liquid where the rod makes contact with the liquid. An increase in the amount of contact with the liquid (higher level of liquid in the tank) increases the level of attenuation.

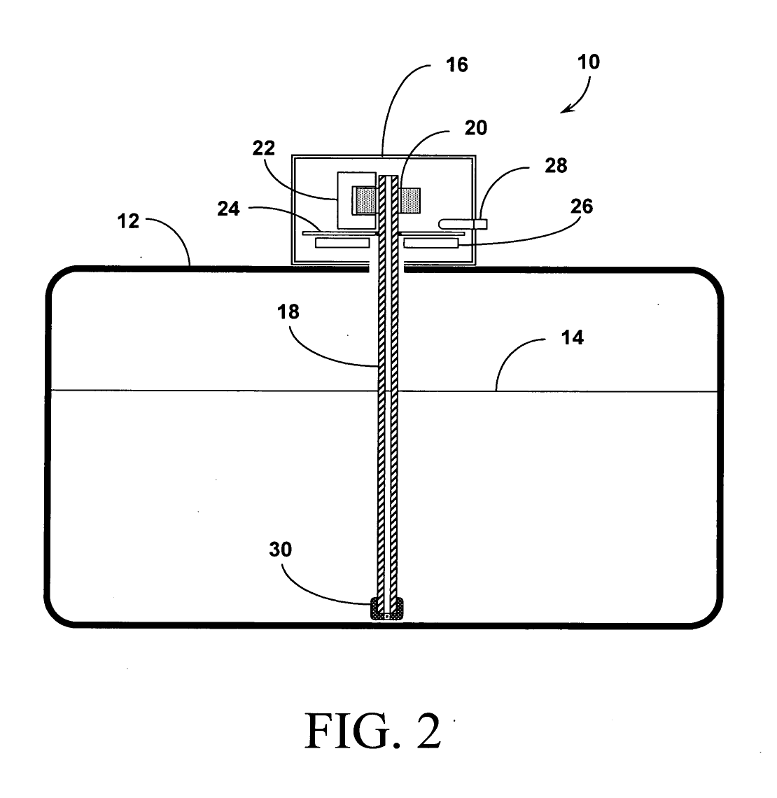

FIG. 2 schematically illustrates a preferred structural embodiment of the apparatus of the present invention as implemented on a typical vehicle fuel tank 12 (as an example) partially filled with a liquid (fuel) 14. The fuel level sensor 10 of the present invention comprises in part, a cylindrical rod or cylinder 18 made of a corrosion resistant and chemical resistant material (such as nickel, stainless steel, etc.) or any material (such as carbon steel, aluminum, etc.) coated with a corrosion resistant and chemical resistant coating. In the preferred embodiment the sensor rod 18 is an open cylindrical tube as opposed to a solid rod. The use of a tube allows the wave refraction to occur on both the inside and outside diameter surfaces resulting in greater wave attenuation. This higher attenuation makes it easier to measure changes and thereby increases the accuracy of the system.

Cylindrical tube 18 is placed inside a fuel tank 12 through an aperture with an appropriate seal and extends into liquid fuel 14 to a point close to (but preferably not in contact with) the base of the tank. The placement of a rubber boot 30 or the like over the end of the cylindrical tube or rod 18 reduces the undesirable interaction between the guided wave and the fuel at the bottom end of the tube or rod. This eliminates direct contact between the bottom end of the rod and the fuel and thereby significantly removes any interaction.

A magnetostrictive sensor (MsS) coil 20 is installed on the extended end of rod 18 outside of fuel tank 12 and is positioned within sensor enclosure 16. The necessary electronics 26 (as described in more detail below) are positioned on PC board 24 which retains signal connector 28 to carry the acquired signal information to a remote or external display and/or processor (not shown).

When ferrous material (such as carbon steel or nickel) is used to construct rod 18, no other preparation of the rod is necessary for MsS operation. When nonferrous material (such as austenitic stainless steel or aluminum) is used to construct rod 18, the area over which coil 20 will be placed may be plated with a thin layer of magnetostrictive material (such as nickel or iron-cobalt alloy) for adequate levels of MsS operation (see descriptions of the same in U.S. Pat. Nos. 5,457,994 and 6,396,262 mentioned above). Instead of plating, a thin strip of magnetostrictive material may be bonded around rod 18 (see again descriptions of the same in U.S. Pat. Nos. 5,457,994 and 6,396,262 mentioned above).

The bias magnetic field used to optimize MsS operation is applied by placing a permanent magnet 22 over the area around coil 20, as illustrated in FIG. 2. Instead of permanent magnets, electromagnets or residual magnetization built into the rod or the magnetostrictive material plated or bonded to the rod can also be used. Once again, to minimize the deposition of any chemicals or particulates in the fuel onto the rod, and to help prevent the corrosive effects of certain liquid compounds, a nonstick coating is preferably applied to at least that portion of the rod that extends into the liquid within the tank.

Guided waves are generated within cylindrical rod or tube 18 by applying a short current pulse into sensor coil 20. The waves travel back and forth along the length of the tube due to the reflective nature of the ends of the tube. Sensor coil 20 in the preferred embodiment acts as both the means for generating the guided waves through the magnetostrictive effect and the means for detecting the guided wave signal and its reverberation through the inverse magnetostrictive effect. One benefit of the system of the present invention is the ability of the single coil (the MsS coil) to act to both generate and detect the guided waves, thereby eliminating the need for a sensor coil separate from the generating coil. All of this contributes to the small package within which the system of the present invention may be implemented and the manner in which it may easily be positioned in conjunction with a relatively small external aperture on the fuel tank.

The above described MsS structure also permits the use of relatively compact electronics to handle the necessary signal generation, signal reception, and signal analysis requirements of the system. PC board 24 connects to and, in the preferred embodiment, helps to support the cylindrical rod or tube 18 as well as positioning and supporting the necessary electronics 26 and a signal connection point 28. It is anticipated that a variety of different output signals could be generated by the sensor system of the present invention, depending upon the nature of the remote (or local) display device or data acquisition device that will ultimately display or record the liquid level in the tank. The fuel level sensor 10 is sized so as to be capable of being mounted to the wall of the tank (through the aperture as shown) with bolts, screws or other common attachment means.

The functionality of the system of the present invention is dependent in part on the manner in which the guided wave signal may be analyzed and compared to reference signal data. The level of wave attenuation in the preferred embodiment is measured by an electronic circuit using one of several methods. A first preferred method captures the peak level of a selected echo signal or group of signals for comparison to an initially calibrated level. A second preferred method utilizes the RMS value of a gated signal over a specified range for comparison to the calibrated reference level. The reference level is preferably set at the zero point (tank empty and minimum attenuation) although other references could be utilized. Attenuation is preferably measured from a reference starting point for each measure signal (calibration reference and level measurement) which in the preferred embodiment is simply the first “clean” end-reflected signal received after the initial pulse and the “dead zone” following the generation of the guided waves into the tube or rod. These methods are described in more detail below.

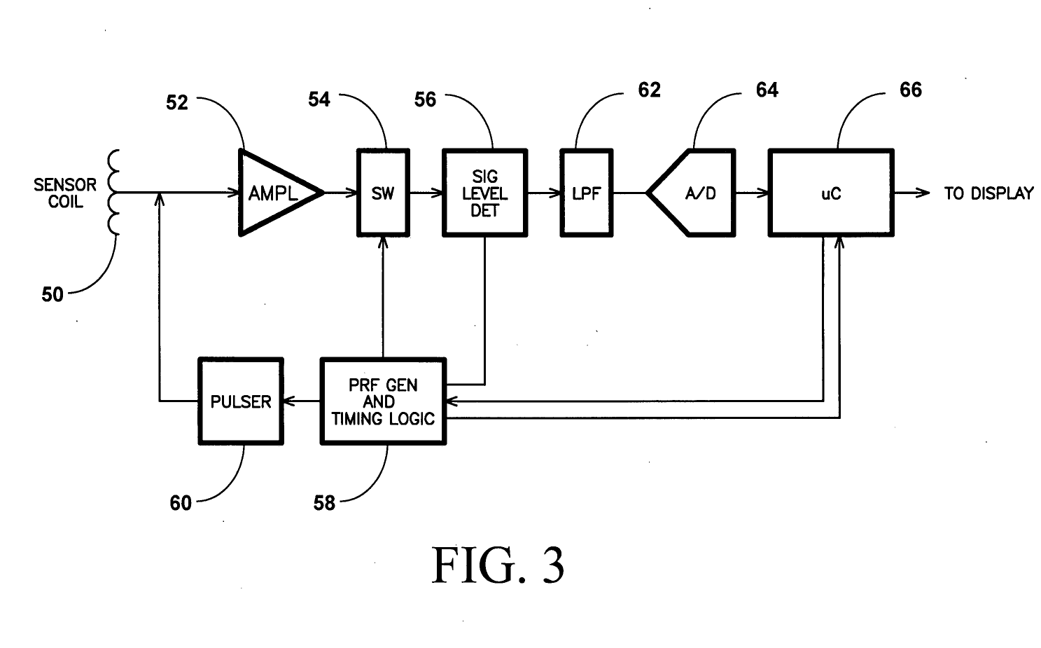

Reference is now made to FIG. 3 for a brief description of a first electronic circuit appropriate for implementing the system and method of the present invention. FIG. 3 shows a block diagram of a circuit that operates to both drive signal generation and carry out signal acquisition in order to establish the level sensing measurement. The circuit initiates a short current pulse via PULSER 60 into sensing coil 50 to launch the guided wave signal. This could occur at a fixed pulse repetition frequency generated by the timing and control logic (PRF GEN & TIMING LOGIC) 58 or in a preprogrammed or pre-set manner by use of an embedded microcontroller (μC) 66.

The echo signals received by sensor coil 50 are amplified to a suitable level by a fixed-gain amplifier (AMPL) 52, passed through an electronic switch (SW) 54 (which is also driven by timing and control logic circuitry 58) used to reject the initial pulse and associated nonlinear saturation effects, and then input to a signal level detection circuit (SIG LEVEL DET) 56. This circuit measures a parameter indicative of signal attenuation such as; (a) an average signal amplitude at a specific location, (b) an average signal amplitude over a gated range, or (c) an RMS value of the waveform (or other signal level measurement techniques), and outputs a voltage signal representing the level. The signal is low-pass filtered (LPF) 62 to eliminate electrical noise and to average out the short-term liquid level uncertainties. Microcontroller (μC) 66 then captures the signal after conversion by the analog-to-digital (A/D) converter 64. The μC 66 subsequently applies a linearization algorithm to determine the actual fuel depth calculated from the signal level detection parameter and the attenuation rate, and outputs the corrected result to a remote digital display. Alternate to sending the digital result to a display, an analog signal could be generated by the μC by outputting the digital depth value into a digital-to-analog converter (not shown) before being sent to a remote meter designed to receive analog voltage or current signals for display of the fuel level.

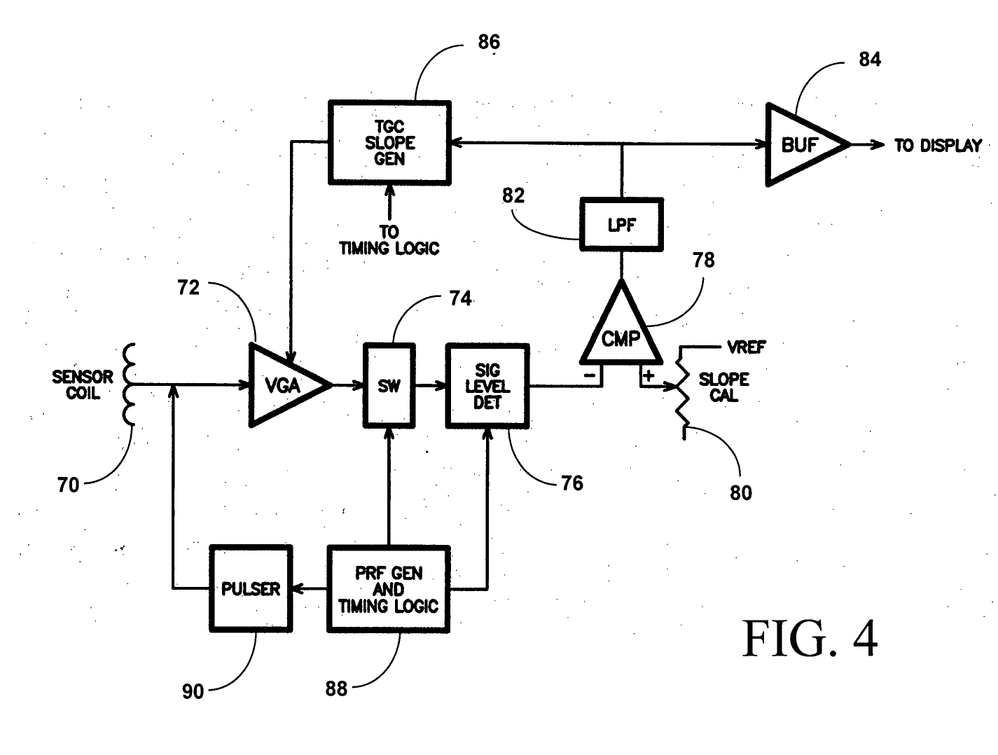

A second embodiment of the electronic sensing circuit is shown in FIG. 4. This circuit replaces the μC with a closed-loop feedback circuit designed to automatically adjust the linear slope of a time-gain control (TGC) 86 circuit whose output is applied to a linear-in-dB variable gain amplifier (VGA) 72. The linear-in-dB function compensates for the nonlinear exponential attenuation of the guided wave signals in the rod as a function of fuel depth. For example, the RMS value of the echo signal waveform output from the signal level detector 76 is compared in comparator (CMP) 78 to a pre-calibrated 80 reference level determined when the liquid level is zero. Typically, this would correspond to a zero or near-zero slope function generated by the TGC 86. As liquid fills the tank, the reflected (reverberating) guided waves attenuate, causing an error signal to be generated by the CMP 78 which, after low-pass filtering 82, increases the TGC 86 slope and gain as a function of time of the VGA 72 as needed to return the CMP 78 error signal back to its calibrated level. The output signal from the LPF 82 will, therefore, automatically provide a voltage signal that is a linear representation of the fuel level. This voltage signal can be scaled, buffered 84, and output to a remote meter that can convert the voltage for visual indication of the fuel level. A variation of this embodiment uses the peak signal level measurement type of signal level detector 76 and eliminates the TGC 86 function. In such a case, the CMP 78 error signal, after low-pass filtering 82, drives the VGA 72 directly.

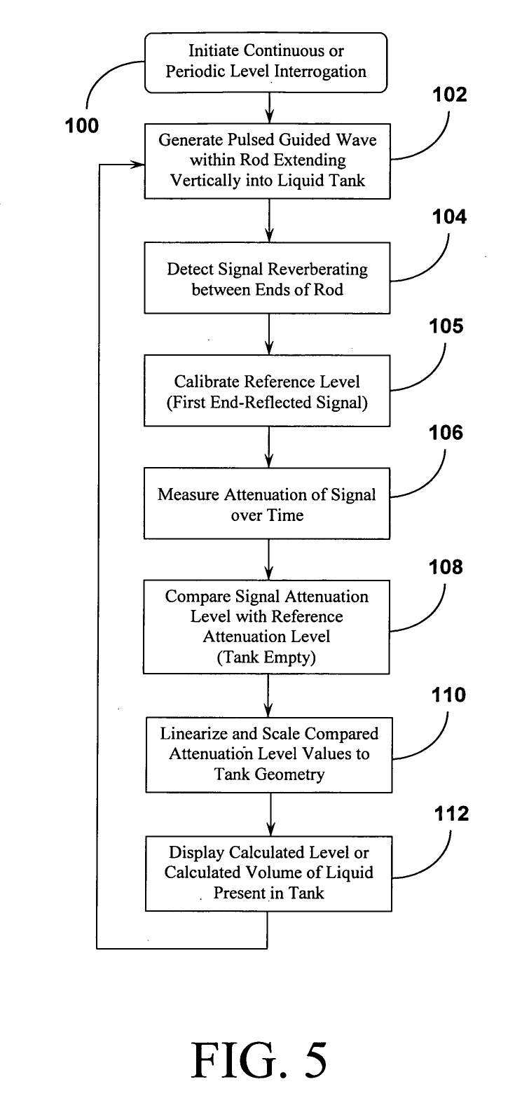

Reference is finally made to FIG. 5 for a brief description of the broad level steps associated with the basic methodology of the present invention. These steps describe generally the actions carried out by the various components of the system described above. The fuel level measurement process is initiated at Step 100 on a continuous or periodic basis. That is, depending on the type of tank and the rate at which the fuel level changes, a continuous monitoring (interrogation) of the level may be implemented or a periodic measurement (one interrogating measurement every 10 minutes, as an example) may be carried out. In any event, the measurement process is initiated with the generation (at Step 102) of a pulsed guided wave within the rod extending into the fuel within the tank. As indicated above, the same MsS used for generating the wave acts as the sensor for detecting the signal reverberating between the ends of the rod (at Step 104).

The signal received is then analyzed and compared to “stored” information in a number of ways. As described above, reference signal information related to the attenuation of the guided wave in the rod while in air is initially measured and used as a baseline for comparison. In addition, an initial wave form is chosen near the beginning of the reverberating signal to use as the attenuation reference point (i.e. the amplitude value to which subsequently measured wave amplitudes are compared). In the preferred embodiment, at Step 105, a first end-reflected signal received after the initial pulse and an initial “dead zone” that provides a clear and accurate amplitude value is used. As described above, various timing and gating functions allow the system to select these features of the signal waveform for analysis and comparison.

The analog or digital signal processing components (as alternately described above) then (at Step 106) measure the attenuation of the signal over time, which degree of attenuation is indicative of the length of the rod or tube that is immersed in the fuel. The measure of the attenuation is then compared (at Step 108) with a calibrated reference attenuation level associated with the tank being empty. The compared attenuation level value is then (at Step 110) linearized and scaled to the specific tank geometry, i.e. the specific fuel level is associated with a volume or other indicator of the degree to which the tank is full. Finally, at Step 112, the system displays the determined fuel level or fuel volume at either a local or remote display device. Alternately, the fuel level or fuel volume information may be recorded for later processing and/or display.

Variations of the system described above are anticipated. For example, the attenuation can be measured from the peaks of each of the end-reflected signals; guided waves can be generated using a piezoelectric transducer; other guided-wave modes, such as flexural and Lamb (or plate) waves, can be used. The advantages of the system of the present invention generally include: (1) an ability to function without moving parts thereby eliminating mechanical wear on the sensor; (2) an ability to function without the need for floats thereby allowing more room for fluid (fuel) within the tank; (3) the placement of the sensor components outside of the fuel tank thereby preventing exposure of the electronic components to fuel chemicals resulting in the safer operation of the system; (4) an ability to obtain consistent liquid level readings; (5) ease of installation; and (6) ease of modification for different tank sizes and geometries.

Although the present invention has been described in terms of the foregoing preferred embodiments, this description has been provided by way of explanation only, and is not intended to be construed as a limitation of the invention. Those skilled in the art will recognize modifications of the present invention that might accommodate specific environments. Such modifications as to size, and even configuration, where such modifications are merely coincidental to the specific application do not necessarily depart from the spirit and scope of the invention.

We claim:

1. An apparatus for measuring the level of a liquid within a tank comprising:
a rod, a first end of which is at least partially immersed in the liquid within the tank and a second end of which at least partially extends outside of the tank, the second end of the rod further at least partially comprising ferromagnetic material;
a magnetostrictive sensor (MsS) comprising a coil at least partially surrounding the second end of the rod;
signal generator circuitry for driving the MsS and thereby generating a longitudinal guided-wave within the rod;
signal receiver circuitry for sensing and receiving a signal from the MsS, generated therein by the longitudinal guided-wave; and
signal analyzer circuitry for measuring and analyzing an attenuation of the guided-wave, the attenuation corresponding to a degree to which the rod is immersed in the liquid.

2. The apparatus of claim 1 wherein the rod comprises a cylindrical tube having an internal diameter and an external diameter defining and internal surface and an external surface, each surface of which may come into contact with the liquid within the tank.

3. The apparatus of claim 1 wherein the rod further comprises a boot positioned on the first end of the rod, the boot generally covering the first end of the rod and preventing contact between an end face of the rod and the liquid within the tank.

4. The apparatus of claim 1 wherein the magnetostrictive sensor (MsS) further comprises a permanent magnet positioned in association with the coil.

5. The apparatus of claim 1 wherein the rod is primarily constructed of ferromagnetic material.

6. The apparatus of claim 1 wherein the rod is primarily constructed of non-ferromagnetic material and a layer of ferromagnetic material is plated on at least the second end of the rod adjacent to the MsS.

7. The apparatus of claim 1 wherein the rod is primarily constructed of non-ferromagnetic material and a thin sheet of ferromagnetic material is bonded on at least the second end of the rod adjacent to the MsS.

8. The apparatus of claim 1 wherein the rod further comprises a coating of corrosion and chemical resistant material.

9. The apparatus of claim 1 wherein the signal analyzer circuitry comprises an analog to digital signal converter and a microcontroller.

10. The apparatus of claim 1 wherein the signal analyzer circuitry comprises a linear-in-dB variable gain amplifier, a time-gain control circuit, and a closed-loop feedback circuit.

11. A method for measuring the level of a liquid within a tank comprising the steps of:
generating longitudinal guided-waves in a rod that is placed inside the tank using a magnetostrictive sensor (MsS);
detecting the guided-waves reverberating in the rod over a period of time with the MsS;
measuring the level of wave attenuation in the reverberating guided-waves in the rod over a period of time;
referencing the measured level of wave attenuation to a calibrated level associated with a known liquid level; and
converting the measured wave attenuation to a measure of the liquid level within the tank.

12. The method of claim 11 further comprising the step of establishing a reference attenuation signal characteristic of an attenuation of guided waves in the rod when no liquid is in the tank and the step of referencing the measured level of wave attenuation comprises referencing the measured level to the reference attenuation signal.

13. The method of claim 11 wherein the step of measuring the level of wave attenuation comprises determining a change in amplitude over time from the amplitude of a first reference signal peak associated with a first end-reflected guided wave received by the MsS.

14. The method of claim 11 wherein the step of converting the measured wave attenuation to a measure of the liquid level within the tank converting the attenuation to a liquid volume based on a linear correlation of the attenuation value with liquid depth and an a-priori knowledge of a volumetric geometry of the tank.

15. The method of claim 11 further comprising the step of displaying the measure of the liquid level within the tank on a visual display device.

16. The method of claim 11 further comprising the step of recording over time a plurality of measures of the liquid level within the tank in a memory storage device.
